(19) United States
(12) Patent Application Publication
(10) Pub. No.: US 2026/0178580 A1
(43) Pub. Date: Jun. 25, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Jongin LEE, Suwon-si (KR); Sunghoon JO, Suwon-si (KR); Sehyun KIM, Suwon-si (KR); Donghwa JEONG, Suwon-si (KR); Donguk KIM, Suwon-si (KR); Minhyo JUNG, Suwon-si (KR); Yeonwoo KIM, Suwon-si (KR)

(73) Assignee: SAMSUNG ELECTRONICS CO., LTD., Suwon-si (KR)

(21) Appl. No.: 19/462,539

(22) Filed: Jan. 28, 2026

Related U.S. Application Data
(63) Continuation of application No. PCT/KR2025/021868, filed on Dec. 16, 2025.

(30) Foreign Application Priority Data
Dec. 20, 2024 (KR) 10-2024-0192296

(51) Int. Cl. G06F 16/2453; G06F 40/40

(52) U.S. Cl. CPC G06F 16/24539; G06F 40/40

(57) ABSTRACT

An electronic apparatus includes memory storing instructions; and at least one processor, wherein, the instructions, when executed by the at least one processor, individually or collectively, cause the electronic apparatus to obtain text data based on a user input including a user inquiry, based on a response data corresponding to the text data being not obtainable using a keyword corresponding to the obtained text data, and based on the response data corresponding to the text data not being included in a query history database, obtain the response data by using the text data with an artificial intelligence model, and output a response to the user input based on the response data.

### CROSS-REFERENCE TO RELATED APPLICATION(S)

This application is a continuation application of International Application No. PCT/KR2025/021868, filed on Dec. 16, 2025, which is based on and claims priority to Korean Patent Application No. 10-2024-0192296, filed on Dec. 20, 2024, in the Korean Intellectual Property Office, the disclosures of which are incorporated by reference herein in their entireties.

### BACKGROUND

### 1. Field

The present disclosure relates to an electronic apparatus and a controlling method thereof, and more particularly, to an electronic apparatus that obtains response data by augmenting a large language model (LLM) using a metadata database, and a controlling method thereof.

### 2. Description of Related Art

Recently, natural language processing algorithms have been rapidly developing.

However, a large language model (LLM) has a large size, and a delay time may thus occur upon obtaining response data.

Therefore, there is a need to find a method to reduce a time required to obtain the response data, by updating the metadata database.

### SUMMARY

According to one or more embodiments of the present disclosure an electronic apparatus obtains response data by augmenting an LLM using a metadata database and a controlling method thereof.

According to an aspect of the disclosure, an electronic apparatus includes memory storing instructions; and at least one processor, wherein, the instructions, when executed by the at least one processor individually or collectively, cause the electronic apparatus to obtain text data based on a user input comprising a user inquiry, based on a response data corresponding to the text data being not obtainable using a keyword corresponding to the obtained text data, and based on the response data corresponding to the text data not being included in a query history database, obtain the response data by using the text data with an artificial intelligence model, and output a response to the user input based on the response data.

The instructions, when executed by the at least one processor individually or collectively, may cause the electronic apparatus to obtain a weight for at least one record based on a weight value assigned to at least one keyword in the text data corresponding to a predetermined field, wherein the predetermined field comprises at least one of a title, a director name, a genre type, an actor name, or a production year, of a movie, wherein the at least one record is stored in a metadata database with a field matching the predetermined field corresponding to the at least one keyword, and obtain the response data based on records from among the at least one record having a weight greater than or equal to a threshold value.

The query history database may include (i) a feature vector corresponding to the text data and (ii) the response data, the feature vector being an embedding vector corresponding to the text data, and wherein whether the response data is included in the query history database is identified based on the feature vector matches one of a plurality of feature vectors stored in the query history database.

The feature vector may be matched to the one of the plurality of feature vectors based on a cosine similarity value between the feature vector and the one of the plurality of feature vectors being greater than or equal to a threshold value.

The response data may include at least one of data obtained from the artificial intelligence model based on the text data or augmented data used for updating the metadata database.

The memory may store a prompt for obtaining the augmented data from the artificial intelligence model, and the instructions, when executed by the at least one processor individually or collectively, may cause the electronic apparatus to obtain the augmented data based on inputting the text data and the prompt into the artificial intelligence model.

The augmented data may include at least one of a genre, a title, a summary, a production year, or rating information, and the instructions, when executed by the at least one processor, individually or collectively, may cause the electronic apparatus to update the query history database with the augmented data.

The instructions, when executed by the at least one processor individually or collectively, may cause the electronic apparatus to transmit the response data to an external device, receive a selection of at least a portion of the response data from the external device, and match the text data to the selection and store the matched text data and selection in the query history database.

The instructions, when executed by the at least one processor individually or collectively, may cause the electronic apparatus to transmit, based on no records having a weight greater than or equal to the threshold value, response data to an external device corresponding to a predetermined number of records in the metadata database having the highest weights.

The instructions, when executed by the at least one processor individually or collectively, may cause the electronic apparatus to, based on the keyword not being identified obtain the response data by processing the text data with the artificial intelligence model if the keyword corresponding to the text data is not identifiable, and transmit the output response to an external device.

According to an aspect of the disclosure, a method of controlling an electronic apparatus includes obtaining text data based on a received user input comprising a user inquiry; based on a response data corresponding to the text data being not obtainable using a keyword corresponding to the obtained text data, and based on the response data corresponding to the text data not being included in a query history database, obtaining the response data by processing the text data with an artificial intelligence model; and outputting a response to the received user input based on the response data.

The obtaining the response data may include obtaining a weight for at least one record based on a weight value assigned to at least one keyword in the text data corresponding to a predetermined field; wherein the predetermined field comprises at least one of a title, a director name, a genre type, an actor name, or a production year, of a movie, wherein the at least one record is stored in a metadata database with a field matching the predetermined field corresponding to the at least one keyword, and obtaining the response data based on records from among the at least one record having a weight value greater than or equal to a threshold value from a metadata database.

The query history database may include (i) a feature vector corresponding to the text data and (ii) the response data, the feature vector being an embedding vector corresponding to the text data, and wherein whether the response data is included in the query history database is identified based on the feature vector matches one of a plurality of feature vectors stored in the query history database.

The feature vector may be matched to the one of the plurality of feature vectors based on a cosine similarity value between the feature vector and the one of the plurality of feature vectors being greater than or equal to a threshold value.

The response data may include at least one of data obtained from the artificial intelligence model based on the text data or augmented data used for updating the metadata database.

A prompt may be stored in memory for obtaining the augmented data from the artificial intelligence model, and the augmented data may be obtained based on inputting the text data and the prompt into the artificial intelligence model.

The augmented data may include at least one of a genre, a title, a summary, a production year, or rating information, and the controlling method may further include updating the query history database with the augmented data.

The controlling method may further include transmitting the response data to an external device, receiving a selection of at least a portion of the response data from the external device, and matching the text data to the selection and store the matched text data and selection in the query history database.

The controlling method may further include transmitting, based on no records having a weight greater than or equal to the threshold value, response data to an external device corresponding to a predetermined number of records in the metadata database having the highest weights.

According to an aspect of the disclosure, a non-transitory computer-readable recording medium having at least one instruction recorded thereon, that, when executed by at least one processor, individually or collectively, causes the at least one processor to obtain text data based on a received user input comprising a user inquiry; based on a response data corresponding to the text data being not obtainable using a keyword corresponding to the obtained text data, and based on the response data corresponding to the text data not being included in a query history database, obtain the response data by using the text data with an artificial intelligence model; and output a response to the received user input based on the response data.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a diagram for describing a system for obtaining response data corresponding to a user inquiry according to an embodiment of the present disclosure.

FIG. 2 is a block diagram for describing components included in the electronic apparatus according to an embodiment of the present disclosure;

FIG. 3 is a flowchart for describing a case where a keyword included in text data is unable to be recognized, according to an embodiment of the present disclosure;

FIG. 4 is a diagram for describing a metadata database according to an embodiment of the present disclosure;

FIG. 5 is a flowchart for describing a process for obtaining response data in a case where the response data having a weight greater than or equal to a threshold value is obtainable from the metadata database, according to an embodiment of the present disclosure;

FIG. 6 is a flowchart for describing an embodiment in which the response data having the weight greater than or equal to the threshold value is not obtainable according to an embodiment of the present disclosure;

FIG. 7 is a diagram for describing a query history database according to an embodiment of the present disclosure;

FIG. 8 is a diagram for describing a method for obtaining a cosine similarity value between vectors according to an embodiment of the present disclosure;

FIG. 9 is a flowchart for describing an embodiment in which a matched feature vector is not identified from the query history database, according to an embodiment of the present disclosure;

FIG. 10 is a diagram for describing a method for obtaining augmented data according to an embodiment of the present disclosure;

FIG. 11 is a diagram for describing an embodiment of displaying the response data on a user terminal device.

FIG. 12 is a block diagram for describing components included in the user terminal device according to an embodiment of the present disclosure; and

FIG. 13 is a flowchart for describing a method for controlling an electronic apparatus according to an embodiment of the present disclosure.

### DETAILED DESCRIPTION

The present disclosure may be variously modified and have several embodiments, and specific embodiments of the present disclosure are thus illustrated in the accompanying drawings and described in detail in this specification. However, it should be understood that the scope of the present disclosure are not limited to specific embodiments, and include all modifications, equivalents, and alternatives according to an embodiment of the present disclosure. Throughout the accompanying drawings, similar components are denoted by similar reference numerals.

In the present disclosure, description of known functions or configurations related to the present disclosure may be omitted to avoid unnecessarily obscuring the gist of the present disclosure.

In addition, the following embodiments may be modified in several different forms, and the scope and spirit of the present disclosure are not limited to the following embodiments. Rather, these embodiments make the present disclosure thorough and complete, and are provided to completely convey the spirit of the present disclosure to those skilled in the art.

Terms used in the present disclosure are used only to describe the specific embodiments rather than limit the scope of the present disclosure. A term of a singular number may include its plural number unless explicitly indicated otherwise in the context.

In the present disclosure, the expression such as “have”, “may have”, “include”, or “may include”, indicates the presence of a corresponding feature (for example, a numerical value, a function, an operation, or a component such as a part), and does not exclude the presence of an additional feature.

In the present disclosure, the expression such as “A or B”, “least one of A and/or B”, or “one or more of A and/or B” may include all possible combinations of items enumerated together. For example, “A or B”, “at least one of A and B”, or “at least one of A or B” may indicate all of 1) a case in which A is included, 2) a case in which B is included, or 3) a case in which both of A and B are included.

The expressions such as “first” and “second”, used in the present disclosure, may indicate various components regardless of the sequence and/or importance of the components. These expressions are only used to distinguish one component and another component from each other, and do not limit the corresponding components.

If any component (for example, a first component) is mentioned to be “(operatively or communicatively) coupled with/to” or “connected to” another component (for example, a second component), it should be understood that the any component is directly coupled to another component or may be coupled to another component through yet another component (for example, a third component).

On the other hand, if any component (for example, the first component) is mentioned to be “directly coupled with/to” or “directly connected to” another component (for example, the second component), it should be understood that yet another component (for example, the third component) is not present between any component and another component.

An expression such as “configured (or set) to”, used in the present disclosure, may be replaced by an expression such as “suitable for”, “having the capacity to”, “designed to”, “adapted to”, “made to”, or “capable of”, depending on a context. The expression “configured (or set) to” does not necessarily indicate “specifically designed to” in terms of hardware.

Instead, the expression “a device configured to”, in any context, may indicate that the device may “perform˜” together with another device or component. For example, a “processor configured (or set) to perform A, B, and C” may indicate a dedicated processor (for example, an embedded processor) that may perform the corresponding operations or a general-purpose processor (for example, a central processing unit (CPU) or an application processor) that may perform the corresponding operations by executing one or more software programs stored in a memory device.

In the embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by the processor except for a “module” or a “part” that needs to be implemented by specific hardware.

Meanwhile, the various elements and areas in the drawings are schematically shown. Therefore, the spirit of the present disclosure is not limited by relative sizes or intervals shown in the accompanying drawings.

Hereinafter, various embodiments of the present disclosure are described in detail with reference to the accompanying drawings.

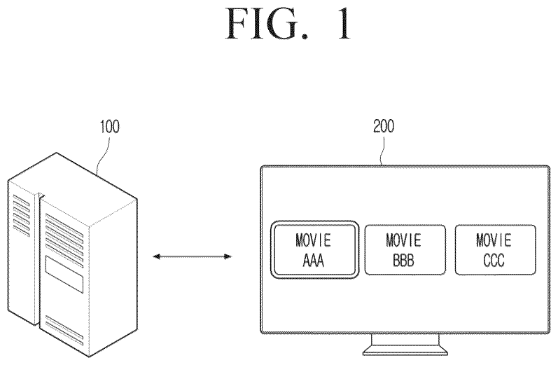

FIG. 1 is a diagram showing a system for obtaining response data corresponding to a user inquiry according to an embodiment of the present disclosure. As shown in FIG. 1, the system may include an electronic apparatus 100 and a user terminal device 200. Here, the electronic apparatus 100 may be implemented as a server as shown in FIG. 1, which is only an embodiment, and may be implemented as any of various electronic apparatuses such as a tablet, a laptop, or a television (TV). In addition, the user terminal device 200 may be implemented as a TV as shown in FIG. 1, which is only an embodiment, and may be implemented as any of various terminal devices such as a tablet, a laptop, or a smartphone.

The user terminal device 200 may receive a user input including the user inquiry (e.g., a user voice or a user touch) and transmit text data corresponding to the received user input to the electronic apparatus 100.

The electronic apparatus 100 may obtain the text data from the user terminal device 200, such as “I'm looking for a movie about a mass murder case. The movie includes a lot of snowy scenes and some driving scenes.”

The electronic apparatus 100 may identify a keyword, such as “a lot of snowy scenes”, “a mass murder”, or “a movie about a murder case”, from a plurality of text segments included in the text data, and then identify whether a matched movie is included in a plurality of movies stored in a metadata database based on the identified keyword.

Here, the “metadata database” may be a database that includes information about media data. For example, if the metadata database includes detailed information about a movie, the metadata database may include “a title of the movie”, “an identification number of the movie”, “a director of the movie”, “resolution information”, “subtitle information” or “audio information.” Meanwhile, in the present disclosure, for convenience of description, the metadata database is assumed to be a database that includes the information about the movie, and is described below accordingly. In addition, the metadata database may be referred to as a first database.

If the electronic apparatus 100 identifies a matched movie from the metadata database based on the keyword included in the text data input by a user, the electronic apparatus 100 may transmit matching information about the movie to the user terminal device 200.

The electronic apparatus 100 may convert the text data input by the user into a feature vector if it is identified that the matched movie is not included in the metadata database. Here, the electronic apparatus 100 may identify whether a vector matched to the feature vector converted from the text data is included in a plurality of feature vectors stored in a query history database. Here, the “query history database” may be a database that matches the feature vector corresponding to the text data to response data corresponding to the text data and store the same. In addition, the “query history database” may be referred to as a second database.

For example, the electronic apparatus 100 may identify whether the matched feature vector is included in the feature vectors converted from “I'm looking for a movie about a mass murder case. The movie includes a lot of snowy scenes and some driving scenes.” and the feature vectors stored in the query history database.

Here, if it identified that the matched feature vector is included in the query history database, the electronic apparatus 100 may transmit response data corresponding to the matched feature vector in the query history database to the user terminal device 200.

If the response data corresponding to the matched feature vector are “movie AAA”, “movie BBB”, or “movie CCC”, the electronic apparatus 100 may transmit information about “movie AAA”, “movie BBB”, or “movie CCC” to the user terminal device 200. As shown in FIG. 1, the user terminal device 200 may display the received information about the movie on a display 230.

Here, if the user selects “movie AAA”, the electronic apparatus 100 may match the feature vector converted from “I'm looking for a movie about a mass murder case. The movie includes a lot of snowy scenes and some driving scenes” to data about “movie AAA” and store (or update) the same in the query history database.

However, if the matched feature vector is not identified from the query history database, the electronic apparatus 100 may obtain the response data by using a large language model (LLM).

For example, the electronic apparatus 100 may obtain “augmented data” and “recommended movie data” (or the response data) by inputting the text and prompt “I'm looking for a movie about a mass murder case. The movie includes a lot of snowy scenes and some driving scenes” into the LLM. The electronic apparatus 100 may update the metadata database by using the obtained “augment data.” The “augmented data” refers to data for updating the metadata database.

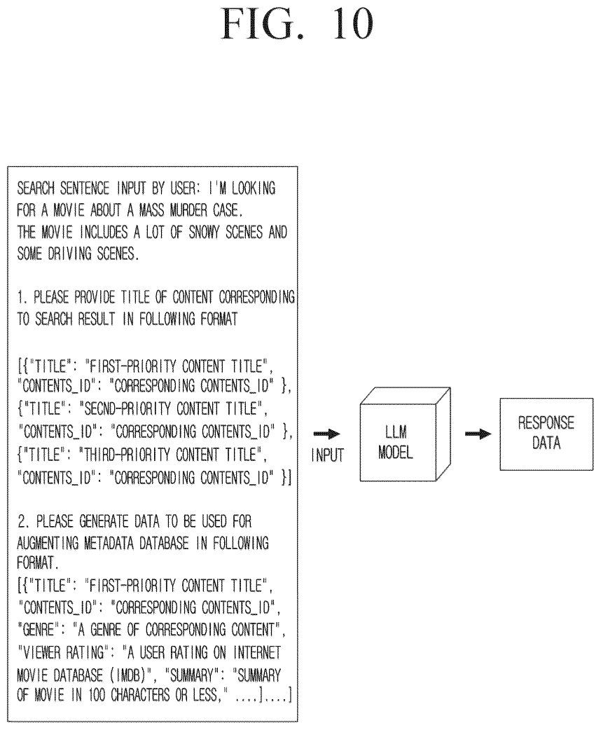

As shown in FIG. 1, the “augmented data” may be information about “movie AAA.” In detail, the “augmented data” may include the identification number, genre, director, release date, rating, lead actor, summary, and lead actor information of “movie AAA.” Meanwhile, a method for obtaining the augmented data is described below with reference to FIG. 10.

The electronic apparatus 100 may provide the information about “movie AAA” if another user inputs similar text data, by updating the query history database and the metadata database.

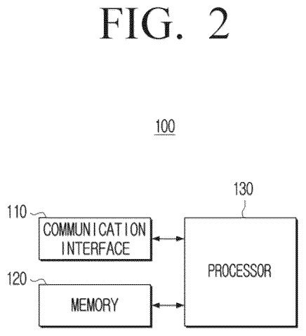

FIG. 2 is a block diagram for describing components included in the electronic apparatus 100.

The components shown in FIG. 2 are only an embodiment, and additional or different components may be added. As shown in FIG. 2, the electronic apparatus 100 may include a communication interface 110, a memory 120, and a processor 130. The components shown in FIG. 2 are only an embodiment, and some components may be changed or added based on a configuration of the electronic apparatus 100.

First, the communication interface 110 is a component for performing communication with various types of external devices by using various types of communication methods. In particular, the communication interface 110 may transmit response data to the user terminal device 200. In addition, the communication interface 110 may receive information about selected data from the user terminal device 200 if the user selects one of the response data.

A wireless communication module may be a module that communicates with the external device in a wireless manner. For example, the wireless communication module may include at least one of a wireless fidelity (Wi-Fi) module, a Bluetooth module, an infrared communication module, an ultrawideband (UWB) module, or other communication modules.

A wired communication module may be a module that communicates with the external device in a wired manner. For example, the wired communication module may include at least one of a local area network (LAN) module, an Ethernet module, a pair of cables, a coaxial cable, or a fiber optic cable.

The memory 120 may store an operating system (OS) for controlling overall operations of the components included in the electronic apparatus 100 and instructions or information related to the components included in the electronic apparatus 100. In particular, the memory 120 may store information about a method for identifying at least one keyword corresponding to a predetermined field from the plurality of text segments included in the text data. In addition, the memory 120 may store the metadata database or the query history database.

Meanwhile, the external device may store the metadata database or the query history database.

The memory 120 may also store the response data obtained by inputting the text data into the LLM or the augmented data used for updating the metadata database.

Meanwhile, for the convenience of description, an LLM model is described below assuming to be stored in the memory 120. However, this configuration is only an embodiment, and the LLM model may be stored in the external device, and received from the external device.

The memory 120 may be implemented in any of various forms, such as a volatile memory (e.g., a dynamic RAM (DRAM)), a static RAM (SRAM), or a synchronous dynamic RAM (SDRAM)) or a non-volatile memory (e.g., a onetime programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash or a NOR flash), a hard drive, or a solid state drive (SSD)).

The processor 130 may include at least one processor. In detail, at least one processor may include at least one of a central processing unit (CPU), a graphic processing unit (GPU), an accelerated processing unit (APU), a many integrated core (MIC), a digital signal processor (DSP), a neural processing unit (NPU), a hardware accelerator, or a machine learning accelerator. The processor 130 may control one or any combination of other components included in the electronic apparatus, and may perform an operation related to the communication or data processing. At least one processor may execute at least one program or instruction stored in the memory. For example, at least one processor may perform a method according to an embodiment of the present disclosure by executing at least one instruction stored in the memory.

At least one processor may be implemented as a single-core processor including a single core, or may be implemented as at least one multi-core processor including multiple cores (e.g., homogeneous multiple cores or heterogeneous multiple cores). If at least one processor is implemented as the multi-core processor, each of the multiple cores included in the multi-core processor may include a processor internal memory such as a cache memory or an on-chip memory, and a common cache shared by the multiple cores may be included in the multi-core processor. In addition, each (or some) of the multiple cores included in the multi-core processor may independently read and perform a program instruction for implementing the method according to an embodiment of the present disclosure, or all (or some) of the multiple cores may be linked with each other to read and perform the program instruction for implementing the method according to an embodiment of the present disclosure.

In particular, the processor 130 may obtain text data based on a received user input including a user query, identify whether response data corresponding to the text is obtainable based on a keyword corresponding to the obtained text data, identify, based on the response data not being obtained based on the keyword, whether the response data corresponding to the text is included in a query history database, obtain, based on the response data not being included in the query history database, the response data by processing the text data with an artificial intelligence model, and may output a response to the received user input based on the response data.

In addition, the processor 130 may obtain (calculate) a weight for the at least one record based on a weight value assigned to each of at least one keyword, and obtain the response data based on the records from among the at least one record having a weight greater than or equal to a threshold value. Here, the field may include at least one of the title, director name, genre type, actor name, or production year of the movie.

In addition, the processor 130 may identify that the response data corresponding to the text data is included in the query history database if the feature vector corresponding to the text data matches one of the plurality of feature vectors stored in the query history database. The query history database may include the feature vector corresponding to the text data and the response data corresponding to the text data, which are matched to each other. Here, the feature vector may be an embedding vector corresponding to the text data. The processor 130 may identify the match if a cosine similarity value between the obtained feature vector and one of the plurality of feature vectors included in the query history database is greater than or equal to a threshold value. Here, the response data may include at least one of the data obtained by using the artificial intelligence model based on the text data or the augmented data used for updating the metadata database. In addition, the memory may store a prompt corresponding to obtaining the augmented data, and the processor 130 may obtain the augmented data based on inputting the text data and the prompt into the artificial intelligence model.

The processor 130 may store and update the obtained augmented data in the query history database. Here, the augmented data may include at least one of a genre, a title, a summary, a production year, or rating information. The processor 130 may transmit the response data to an external device, receive a selection of at least a portion of the response data from the external device, match the text data to the received response data based on the received selection, and store the matched text data and selection in the query history database.

The processor 130 may transmit, based on no records having a weight greater than or equal to the threshold value, response data to an external device corresponding to a predetermined number of records in the metadata database having the highest weights. In addition, the processor 130 may obtain the response data by using the artificial intelligence model based on the text data if the keyword corresponding to the text data is not identifiable, and transmit the obtained response data to the external device.

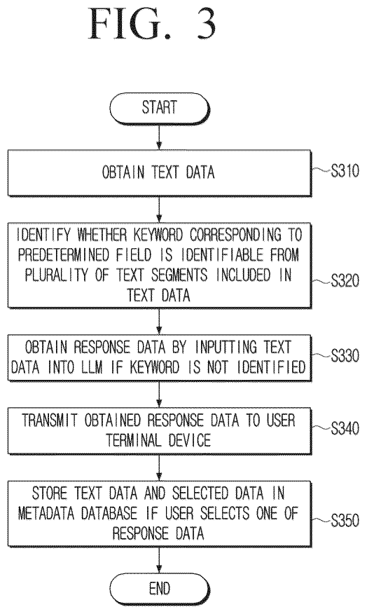

Meanwhile, each of the above-described operations is described below with reference to FIGS. 3 to 10.

First, FIG. 3 is a flowchart for describing a case where a keyword included in text data is unable to be recognized, according to an embodiment of the present disclosure.

First, the electronic apparatus 100 may obtain the text data (S310). Here, the text data may be data that is obtained from the user terminal device 200, in which the user voice is included, and converted into the text. Here, the electronic apparatus 100 may receive a voice signal by using a microphone 240 included in the user terminal device 200. However, this configuration is only an embodiment, and a remote control may be equipped with a microphone, and thus receive the user voice signal.

In addition, the electronic apparatus 100 may execute a remote control application on the user terminal device 200, thereby inputting the voice signal into the user terminal device 200.

Meanwhile, the remote control may communicate with the electronic apparatus 100 through the communication interface. Here, a type of the communication interface used by the electronic apparatus 100 and a type of the communication interface used by the remote control may be the same or different.

The electronic apparatus 100 may identify whether the keyword is identifiable from the plurality of text segments included in the text data (S320). In detail, the electronic apparatus 100 may identify at least one keyword corresponding to the predetermined field from the plurality of text segments included in the text data, and assign the weight value to each of at least one identified keyword, thereby obtaining the weight corresponding to the text data. In addition, the electronic apparatus 100 may identify the response data having the weight greater than or equal to the threshold value from the metadata database. Here, the field may include at least one of the title, director name, genre type, actor name, or production year of the movie.

For example, the electronic apparatus 100 may obtain text data including content “Recommend any interesting movie.” Here, the electronic apparatus 100 may identify whether the field corresponding to one of the “movie title”, the “director name”, the “genre type”, the “actor name”, or the “production year” may be identifiable from the plurality of text segments included in the text data.

The electronic apparatus 100 may obtain the response data by inputting the text data into the LLM if the keyword is unidentifiable from the text data (S330). For example, the electronic apparatus 100 may obtain the response data such as “1. Action/Thriller—Movie AAA, Movie BBB, 2. Comedy—Movie CCC, 3. Animation—Movie DDD.” if the text data, “Recommend any interesting movie” is input into the LLM.

The electronic apparatus 100 may obtain the response data and then transmit the obtained response data to the user terminal device 200 (S340).

The electronic apparatus 100 may store the text data and the selected data in the metadata database if the user selects one of the response data (S350).

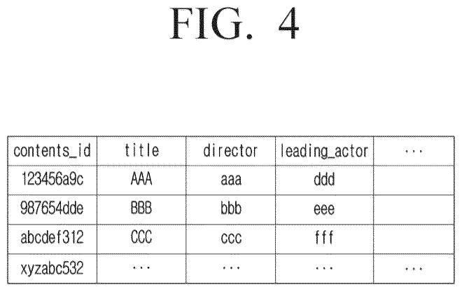

In detail, the electronic apparatus 100 may obtain data input by the user who selects one of the plurality of response data from the user terminal device 200. Here, the electronic apparatus 100 may store the text data and the response data selected by the user in the metadata database. Here, the metadata database is described below with reference to FIG. 4.

As shown in FIG. 4, the electronic apparatus 100 may store the database that includes various information about the media data.

As shown in FIG. 4, the metadata database may include information about the identification number (contents_id), the title (title), the director (director), or the leading actor (leading_actor) of the plurality of media data.

However, this configuration is only an embodiment, and the metadata database may also include information about the running time, release year, release country, and viewer rating of the corresponding video.

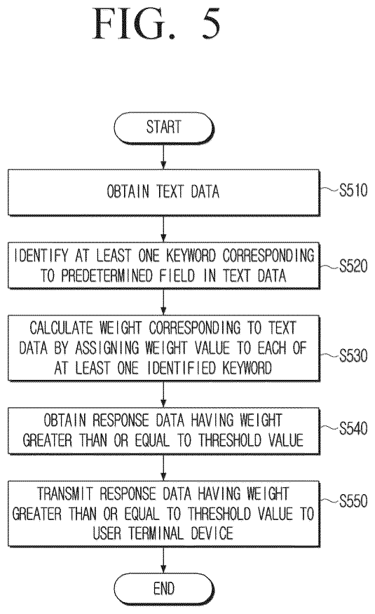

FIG. 5 is a flowchart for describing a process for obtaining the response data in a case where the response data having the weight greater than or equal to the threshold value is obtainable from the metadata database, according to an embodiment of the present disclosure.

Meanwhile, steps S510 to S520 correspond to steps S310 to S320 of FIG. 3. Accordingly, for additional implementation details of steps S510 to S520, reference may be made to the descriptions of steps S310 to S320.

The electronic apparatus 100 may obtain the weight corresponding to the text data by assigning the weight value to each of at least one identified keyword (S530).

In detail, the electronic apparatus 100 may identify at least one keyword corresponding to the predetermined field from the plurality of text segments included in the text data.

For example, the electronic apparatus 100 may set the field as the title, the director, or the genre. Here, the electronic apparatus 100 may set a weight value of a “title” field to 9, a “director” field to 7, or a “genre” field to 5.

The electronic apparatus 100 may obtain text data, “Recommend an animated movie made by director AAA.”

The electronic apparatus 100 may assign a value of 0 to a “title” field of “video 1” in the metadata database, a value of 0.9 to a “director” field, and a weight value of 0.6 to a “genre” field. In this case, a weight assigned to “video 1” may be identified as corresponding to “9*0+7*0.6+5*0.6”, i.e., 7.2.

The electronic apparatus 100 may obtain the weight calculated by summing each data included in the metadata database by the above-described method. The electronic apparatus 100 may obtain the response data having the weight greater than or equal to the threshold value (S540).

The electronic apparatus 100 may transmit the response data having the weight greater than or equal to the threshold value to the user terminal device 200 (S550). For example, if the threshold value is “7”, the electronic apparatus 100 may transmit “video 1” to the user terminal device 200 because the summed weight of “video 1” is “7.1.”

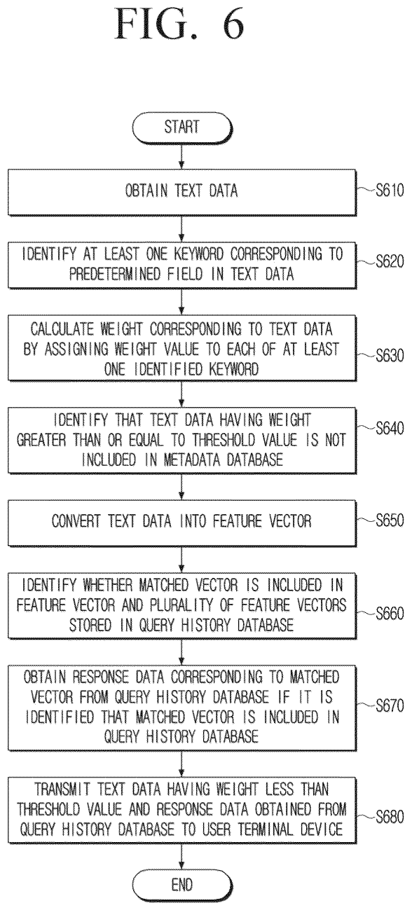

The above-described embodiment describes a case where the response data having the weight greater than or equal to the threshold value may be obtained from the metadata database. However, an embodiment is described hereinafter in which the response data having the weight greater than or equal to the threshold value is not obtainable. This configuration is described below with reference to FIG. 6.

First, steps S610 to S630 of FIG. 6 correspond to steps S510 to S530 of FIG. 5. Accordingly, for additional implementation details of S610 to S630, reference may be made to the descriptions of S510 to S530.

The electronic apparatus 100 may identify that the text data having the weight greater than or equal to the threshold value is not included in the metadata database (S640).

Here, the electronic apparatus 100 may convert the text data into the feature vector (S650). The feature vector may be the embedding vector corresponding to the text data.

The electronic apparatus 100 may identify whether the vector matched to the feature vector is included in the plurality of feature vectors stored in the query history database (S660).

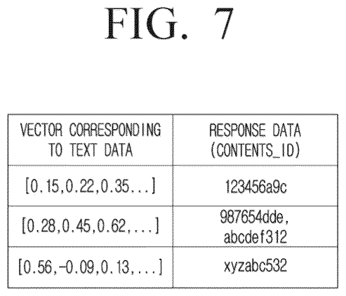

Here, the query history database is described below with reference to FIG. 7.

FIG. 7 is a diagram for describing the query history database according to an embodiment of the present disclosure.

The query history database may include the feature vector corresponding to the text data and the response data corresponding to the text data, which are matched to each other.

For example, if the text data is “a car chase movie having a lot of snowy scenes”, the text data may be converted into a feature vector corresponding to [0.15, 0.22, 0.35].

Here, response data corresponding to “a car chase movie having a lot of snowy scenes” may be “movie AAA”, and the identification number of “movie AAA” may be “123456a9c.” The electronic apparatus 100 may match the feature vector corresponding to [0.15, 0.22, 0.35] to the response data (contents_id) corresponding to “123456a9c” and store the same in the query history database.

Meanwhile, for the convenience of explanation, the above description assumes that one feature vector and one response data are matched to each other, which is only an embodiment, and a plurality of feature vectors and one response data may be matched to each other.

The electronic apparatus 100 may identify the cosine similarity value (i.e., cosine similarity) between the feature vectors to identify whether the vector matched to the feature vector is included in the plurality of feature vectors stored in the query history database.

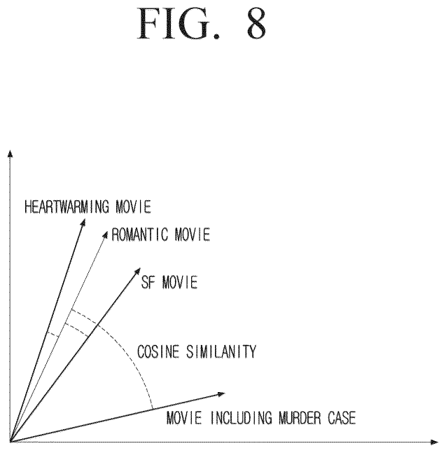

This configuration is described below with reference to FIG. 8.

FIG. 8 is a diagram for describing a method for obtaining the cosine similarity value between the vectors according to an embodiment of the present disclosure.

The plurality of feature vectors stored in the query history database may be shown as the plurality of vectors as shown in FIG. 8.

For example, the feature vector obtained by the electronic apparatus 100 may be a feature vector corresponding to “a heartwarming movie.” Here, the electronic apparatus 100 may identify that the similarity value between the feature vector obtained from the feature vectors stored in the query history database and a feature vector corresponding to “a romantic movie” is greater than or equal to the threshold value. Therefore, the electronic apparatus 100 may identify that the feature vector corresponding to “a heartwarming movie” and the feature vector corresponding to “a romantic movie” are matched to each other.

On the other hand, the electronic apparatus 100 may identify that the cosine similarity value is less than the threshold value because an angle between the feature vector corresponding to “heartwarming movie” and the feature vector corresponding to “a movie including a murder case” is large. Here, the electronic apparatus 100 may identify that the feature vector corresponding to “a heartwarming movie” and the feature vector corresponding to “a movie including a murder case” are not matched to each other.

Meanwhile, for the convenience of description, the method for obtaining the cosine similarity value to identify whether the obtained feature vector and the plurality of feature vectors stored in the query history database are matched to each other is described in detail. However, this configuration is only an embodiment, and the similarity may be determined using Euclidean similarity or vector similarity.

Referring back to FIG. 6, the electronic apparatus 100 may obtain the response data corresponding to the matched vector from the query history database if it is identified that the matched vector is included in the query history database by using the method described above (S670).

In detail, the electronic apparatus 100 may obtain the response data corresponding to the matched vector from the query history database if the electronic apparatus 100 identifies that the matched vector is included in the query history database.

For example, the electronic apparatus 100 may identify that the vector matched to the obtained feature vector is [0.28, 0.45, 0.62]. Here, the electronic apparatus 100 may identify that the response data corresponding to the matched vector is “987654dde” or “abcdef312”, as shown in FIG. 7.

The electronic apparatus 100 may transmit the response data having a weight less than the threshold value and the response data obtained from the query history database to the user terminal device 200 (S680).

For example, if movies corresponding to the response data obtained earlier, “987654dde” and “abcdef312”, are “Movie AAA” and “Movie BBB”, the electronic apparatus 100 may transmit information about “Movie AAA” and “Movie BBB” to the user terminal device 200.

In addition, the electronic apparatus 100 may obtain the predetermined number of response data having the weight less than the threshold value from the metadata database and then transmit the obtained response data to the user terminal device 200 to provide various response data to the user. Here, the obtained response data may be provided to provide the various response data although the obtained response data has a low accuracy in response to a user request.

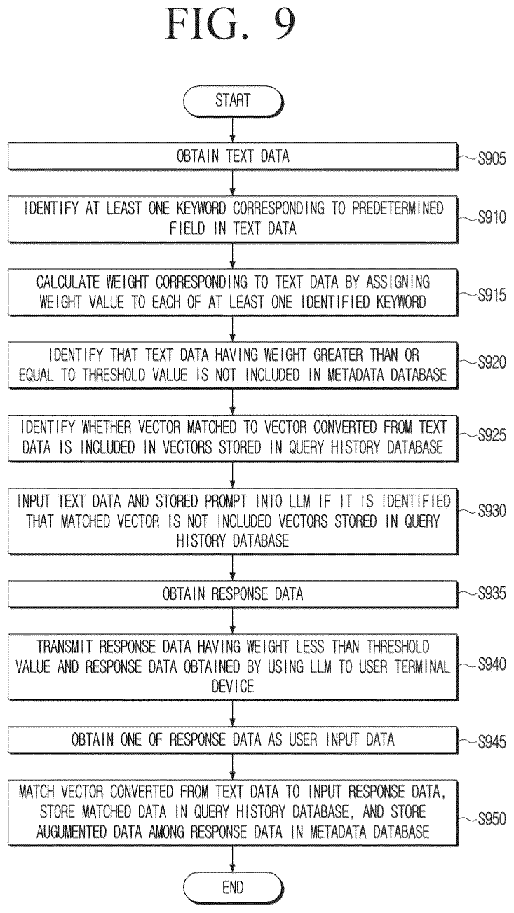

Meanwhile, an embodiment related to identifying the matched feature vector from the query history database is described above. Hereinafter, a case in which feature vector matched to the feature vector corresponding to the text data is not identified from the query history database is described below with reference to FIG. 9.

FIG. 9 is a flowchart for describing an embodiment in which a matched feature vector is not identified from the query history database, according to an embodiment of the present disclosure.

First, steps S905 to S920 overlap with the steps S610 to S640 of FIG. 6. Accordingly, for additional implementation details of S905 to S920, reference may be made to the descriptions of S610 to S640.

First, the electronic apparatus 100 may identify whether the vector matched to the converted vector is included in the vectors stored in the query history database (S925). Meanwhile, this configuration is described in detail with reference to FIG. 6. Accordingly, for additional implementation details, reference may be made to the descriptions of FIG. 6.

The electronic apparatus 100 may input the text data and the stored prompt into the LLM (S930) if it is identified that the matched vector is not included in the query history database. Meanwhile, for the convenience of description, the LLM is described below assuming to be stored in the memory 120, which is only an embodiment, and the LLM may be stored in the external device.

Here, the electronic apparatus 100 may input the text data and the stored prompt into the LLM to obtain the response data (S935). This configuration is described below with reference to FIG. 10.

In detail, the memory 120 may store the prompt for obtaining the augmented data, and input the text data and the prompt into the LLM, thereby obtaining the augmented data.

As shown in FIG. 10, the electronic apparatus 100 may obtain the text data “I'm looking for a movie about a mass murder case. The movie includes a lot of snowy scenes and some driving scenes.” from the user terminal device 200.

Here, the memory 120 may store a prompt in the format of [{“title: “first priority content title”, “contents_id”: “corresponding contents_id” }]. Hereinafter, for the convenience of description, the prompt is described as a first prompt.

In addition, the memory 120 may store a prompt in the format of [{title: “first priority content title”, “contents_id”: corresponding contents_id”, “genre”: “a genre of the corresponding content”, “viewer rating”: “a user rating on an internet movie database (IMDB)}, “summary”: “a summary of the movie in 100 characters or less”, . . . ]. . .] to update the metadata database based on a user response result. Hereinafter, for the convenience of description, the prompt is described as a second prompt.

For example, the electronic apparatus 100 may input the text data, “I'm looking for a movie about a mass murder case. The movie includes a lot of snowy scenes and some driving scenes.” and the first and second prompts shown in FIG. 9 into the LLM.

Here, the electronic apparatus 100 may obtain the response data satisfying a condition “I'm looking for a movie about a mass murder case. The movie includes a lot of snowy scenes and some driving scenes,” and may obtain response data having the format of the first prompt and response data having the format of the second prompt.

Referring back to FIG. 9, the electronic apparatus 100 may transmit the response data having the weight less than the threshold value and the response data obtained by using the LLM to the user terminal device 200 (S940).

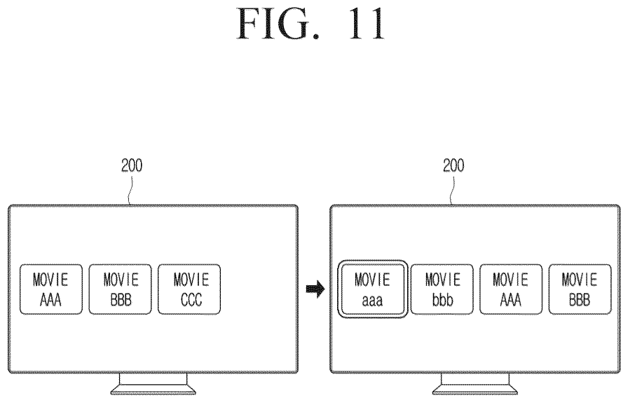

Meanwhile, this configuration is described below in detail with reference to FIG. 11.

The electronic apparatus 100 may transmit the plurality of response data to the user terminal device 200. Here, the electronic apparatus 100 may preferentially transmit the response data having the weight less than the threshold value to the user terminal device 200. Here, the user terminal device 200 may display the response data having the weight less than the threshold value on the display 230.

Next, the electronic apparatus 100 may input the text data and the prompt into the LLM and transmit the obtained response data to the user terminal device 200. The user terminal device 200 may display the response data obtained by using the LLM on the display 230.

The electronic apparatus 100 may preferentially transmit the response data having the weight less than the threshold value to the user terminal device 200. For example, the response data having the weight less than the threshold value may be “Movie AAA”, “Movie BBB”, and “Movie CCC”. Here, as shown on a left side of FIG. 11, the user terminal device 200 may display the information about “Movie AAA”, “Movie BBB”, and “Movie CCC” on the display 230. The order in which the movies are displayed may be displayed in the order of higher to lower weights.

The electronic apparatus 100 may transmit the response data having the weight less than the threshold value to the user terminal device 200, and then input the text data and the prompt into the LLM to thus transmit the obtained response data, i.e., information about “movie aaa” and “movie bbb”, to the user terminal device 200. Here, as shown on a right side of FIG. 11, the information about “movie aaa” and “movie bbb” may be displayed on the leftmost side, and the information about “movie AAA” and “movie BBB” may be displayed on the right side. Meanwhile, the order in which the information about the movies is displayed may be changed.

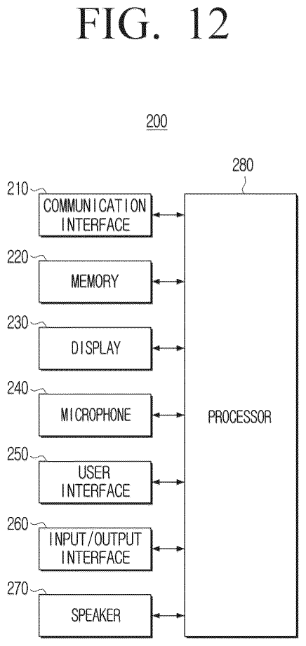

FIG. 12 is a block diagram for describing components included in the user terminal device 200 according to an embodiment of the present disclosure.

The components shown in FIG. 12 are only an embodiment, and some components may be changed or added. As shown in FIG. 12, the user terminal device 200 may include a communication interface 210, a memory 220, the display 230, the microphone 240, a user interface 250, an input/output interface 260, a speaker 270, and a processor 280. The components shown in FIG. 12 are only an embodiment, and some components may be deleted or added based on a configuration of the user terminal device 200.

Meanwhile, among the components included in the user terminal device 200, for implementation details of components overlapping with those shown in FIG. 2, such as the communication interface 210, the memory 220, and the processor 280, reference may be made to the descriptions of FIG. 2.

The communication interface 210 is a component for performing communication with various types of external devices by using various types of communication methods. In particular, the communication interface 210 may transmit the information about the text input by the user to the electronic apparatus 100. Meanwhile, this configuration is only an embodiment, and the electronic apparatus 100 may convert the voice signal input by the user into the text, and transmit the data converted into the text.

Meanwhile, the communication interface 210 may receive the response data from the electronic apparatus 100, and transmit information about the selected response data to the electronic apparatus 100 if the user selects one of the received response data.

The memory 220 may store an operating system (OS) for controlling overall operations of the components included in the user terminal device 200 and instructions or information related to the components of the user terminal device 200. In particular, the memory 220 may also store data input by the user.

The display 230 may display various information. In detail, the display 230 may display the response data received from the electronic apparatus 100. Meanwhile, as described in detail with reference to FIG. 11, the display 230 may display the plurality of response data each having the weight less than the threshold value, and subsequently display the response data obtained by using LLM. However, this configuration is only an embodiment, and the display 230 may simultaneously display the response data having the weight less than the threshold value and the response data obtained by using LLM.

The display 230 may be implemented as any of various forms of displays, such as a liquid crystal display (LCD), an organic light-emitting diode (OLED) display, or a plasma display panel (PDP). The display may also include a driving circuit, a backlight unit, and the like, which may be implemented in a form such as an amorphous silicon thin film transistor (a-si TFT), a low temperature poly silicon (LTPS) TFT, or an organic TFT (OTFT). The display may be implemented as a touchscreen combined with a touch sensor, a flexible display, a three-dimensional (3D) display, or the like. According to the various embodiments of the present disclosure, the display 230 may include not only a display panel that outputs an image, but also a bezel that houses the display panel.

The microphone 240 may indicate a module that obtains sound and converts the same into an electric signal, and may be a condenser microphone, a ribbon microphone, a moving coil microphone, a piezoelectric element microphone, a carbon microphone, a micro electro mechanical system (MEMS) microphone. In addition, the microphone 150 may be implemented in an omnidirectional, bidirectional, unidirectional, subcardioid, supercardioid, or hypercardioid manner.

According to an embodiment, the microphone 240 may receive a user voice command. According to an example, the microphone 240 may obtain a sound corresponding to the voice command and convert the same into an audio signal.

The user interface 250 may be implemented as a device such as a button, a touch pad, a mouse, or a keyboard, or may also be implemented as a touchscreen capable of performing both the above-described display function and a manipulation input function. Here, the button may be any of various types of buttons, such as a mechanical button, a touch pad, or a wheel, and may be disposed on any portion of a body appearance of the user terminal device 200, such as a front surface, a side surface, or a rear surface. The user terminal device 200 may obtain the data by inputting one of the plurality of response data through the user interface 250.

The input/output interface 260 is a component for inputting and outputting at least one of the audio signal or a video signal. For example, the input/output interface 260 may be a high definition multimedia interface (HDMI), which is only an embodiment, and may be any one of a mobile high-definition link (MLHL), a universal serial bus (USB), a DisplayPort (DP), Thunderbolt, a video graphics array (VGA) port, a red-green-blue (RGB) port, a D-subminiature (D-SUB), or a digital visual interface (DVI). According to an implementation example, the input/output interface 260 may include a port for inputting and outputting only the audio signal and a port for inputting and outputting only the video signal as separate ports, or may be implemented as a single port for inputting and outputting both the audio signal and the video signal.

The speaker 270 is a component for outputting various types of notification sounds or voice messages as well as various audio data on which various processing operations such as decoding, amplification, and noise filtering are performed by an audio processing part. In particular, the speaker 270 may output a voice for receiving the user input. The speaker 270 may also output the voice even if the response data is provided before receiving the user input. The component for outputting the audio may be implemented as the speaker, which is only an embodiment, and may be implemented as an output terminal capable of outputting the audio data.

The processor 280 may receive the response data from the electronic apparatus 100 through the communication interface 210. Here, the processor 280 may receive the response data and then display the response data on the display 230. If the user inputs one of the data corresponding to the displayed response data, the processor 280 may transmit the input data to the electronic apparatus 100.

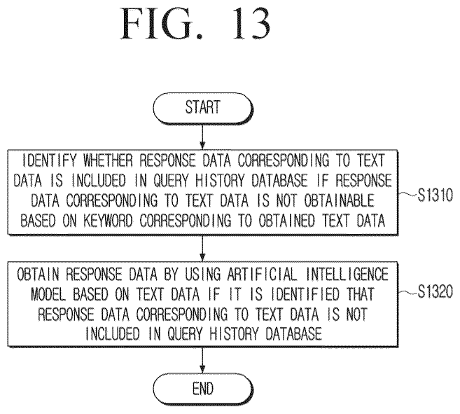

FIG. 13 is a flowchart for describing a method for controlling an electronic apparatus according to an embodiment of the present disclosure.

First, the electronic apparatus 100 may identify whether the response data corresponding to the text data is included in the query history database if the response data corresponding to the text is not obtainable based on the keyword corresponding to the obtained text data (S1310). Here, the electronic apparatus 100 may identify at least one keyword corresponding to the predetermined field from the plurality of text segments in the text data, and assign the weight to the identified keyword. This configuration is described in detail above.

The electronic apparatus 100 may obtain the response data by using the artificial intelligence model based on the text data if it is identified that the response data corresponding to the text data is not included in the query history database (S1320). Meanwhile, an embodiment related to obtaining the response data by using the LLM stored in the memory of the electronic apparatus 100 is described above. However, this configuration is only an embodiment, and the electronic apparatus 100 may obtain the response data from the external device. Here, the response data may include at least one of the data obtained by inputting the text data into the LLM or the augmented data used for updating the metadata database.

According to the present disclosure, the electronic apparatus 100 may store the text data input by the user and the response data corresponding to the text data in the metadata database. In addition, the electronic apparatus 100 may perform a computation process efficiently even by using limited resources because the electronic apparatus 100 does not repeat the process of inputting the text data into the LLM model based on a user input result.

In addition, the methods according to the various embodiments disclosed in the present disclosure may be included and provided in a computer program product. The computer program product may be traded as a commodity between a seller and a purchaser. The computer program product may be distributed in a form of the machine-readable storage medium (e.g., a compact disc read only memory (CD-ROM)), or may be distributed online (e.g., by download or upload) via an application store (e.g., PlayStore™) or directly between two user devices 20 (e.g., smartphones). In case of the online distribution, at least a part of the computer program product (e.g., downloadable app) may be at least temporarily stored or temporarily provided in the machine-readable storage medium such as the memory of a manufacturer server, an application store server, or a relay server.

The methods according to the various embodiments of the present disclosure may be implemented by software including an instruction stored in the machine-readable storage medium (for example, a computer-readable storage medium). A machine may be an apparatus that invokes the stored instruction from the storage medium, may be operated based on the invoked instruction, and may include a server device or the electronic apparatus according to the disclosed embodiments.

Meanwhile, a machine-readable storage medium may be provided in the form of a non-transitory computer-readable storage medium. Here, the “non-transitory computer-readable storage medium” may refer to a tangible device and only indicate that this storage medium does not include a signal (e.g., electromagnetic wave), and this term does not distinguish a case where data is stored semi-permanently in the storage medium and a case where information is temporarily stored in the storage medium from each other. For example, the “non-transitory storage medium” may include a buffer in which data is temporarily stored.

If the instruction is executed by the processor, the processor may directly perform a function corresponding to the instruction or other components may perform the function corresponding to the instruction under a control of the processor. The instruction may include a code provided or executed by a compiler or an interpreter.

Although the embodiments of the present disclosure are shown and described as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic apparatus comprising:
memory storing instructions; and
at least one processor,
wherein, the instructions, when executed by the at least one processor individually or collectively, cause the electronic apparatus to:
obtain text data based on a user input comprising a user inquiry,
based on a response data corresponding to the text data being not obtainable using a keyword corresponding to the obtained text data, and based on the response data corresponding to the text data not being included in a query history database, obtain the response data by using the text data with an artificial intelligence model, and
output a response to the user input based on the response data.

2. The electronic apparatus as claimed in claim 1, wherein the instructions, when executed by the at least one processor individually or collectively, cause the electronic apparatus to:
obtain a weight for at least one record based on a weight value assigned to at least one keyword in the text data corresponding to a predetermined field,
wherein the predetermined field comprises at least one of a title, a director name, a genre type, an actor name, or a production year, of a movie,
wherein the at least one record is stored in a metadata database with a field matching the predetermined field corresponding to the at least one keyword, and
obtain the response data based on records from among the at least one record having a weight greater than or equal to a threshold value.

3. The electronic apparatus as claimed in claim 1, wherein the query history database comprises (i) a feature vector corresponding to the text data and (ii) the response data, the feature vector being an embedding vector corresponding to the text data, and
wherein whether the response data is included in the query history database is identified based on the feature vector matching one of a plurality of feature vectors stored in the query history database.

4. The electronic apparatus as claimed in claim 3, wherein the feature vector is matched to the one of the plurality of feature vectors based on a cosine similarity value between the feature vector and the one of the plurality of feature vectors being greater than or equal to a threshold value.

5. The electronic apparatus as claimed in claim 2, wherein the response data comprises at least one of data obtained by the artificial intelligence model based on the text data or augmented data used for updating the metadata database.

6. The electronic apparatus as claimed in claim 5, wherein the memory stores a prompt for obtaining the augmented data from the artificial intelligence model, and
wherein the instructions, when executed by the at least one processor individually or collectively, cause the electronic apparatus to obtain the augmented data based on inputting the text data and the prompt into the artificial intelligence model.

7. The electronic apparatus as claimed in claim 6, wherein the augmented data comprises at least one of a genre, a title, a summary, a production year, or rating information, and
wherein the instructions, when executed by the at least one processor individually or collectively, cause the electronic apparatus to update the query history database with the augmented data.

8. The electronic apparatus as claimed in claim 1, wherein the instructions, when executed by the at least one processor individually or collectively, cause the electronic apparatus to:
transmit the response data to an external device,
receive a selection of at least a portion of the response data from the external device, and
match the text data to the selection and store the matched text data and selection in the query history database.

9. The electronic apparatus as claimed in claim 2, wherein the instructions, when executed by the at least one processor individually or collectively, cause the electronic apparatus to transmit, based on no records having a weight greater than or equal to the threshold value, response data to an external device corresponding to a predetermined number of records in the metadata database having the highest weights.

10. The electronic apparatus as claimed in claim 1, wherein the instructions, when executed by the at least one processor individually or collectively, cause the electronic apparatus to:
based on the keyword corresponding to the text data not being identifiable, obtain the response data by processing the text data with the artificial intelligence model, and
transmit the response data to an external device.

11. A method of controlling an electronic apparatus, the method comprising:
obtaining text data based on a user input comprising a user inquiry;
based on a response data corresponding to the text data being not obtainable using a keyword corresponding to the obtained text data, and based on the response data corresponding to the text data not being included in a query history database, obtaining the response data by using the text data with an artificial intelligence model; and
outputting a response to the user input based on the response data.

12. The method as claimed in claim 11, wherein the obtaining the response data comprises:
obtaining a weight for at least one record based on a weight value assigned to at least one keyword in the text data corresponding to a predetermined field;
wherein the predetermined field comprises at least one of a title, a director name, a genre type, an actor name, or a production year, of a movie,
wherein the at least one record is stored in a metadata database with a field matching the predetermined field corresponding to the at least one keyword, and
obtaining the response data based on records from among the at least one record having a weight value greater than or equal to a threshold value from a metadata database.

13. The method as claimed in claim 11, wherein the query history database comprises (i) a feature vector corresponding to the text data and (ii) the response data, the feature vector being an embedding vector corresponding to the text data, and
wherein whether the response data is included in the query history database is identified based on the feature vector matching one of a plurality of feature vectors stored in the query history database.

14. The method as claimed in claim 13, wherein the feature vector is matched to the one of the plurality of feature vectors based on a cosine similarity value between the feature vector and the one of the plurality of feature vectors being greater than or equal to a threshold value.

15. The method as claimed in claim 12, wherein the response data comprises at least one of data obtained from the artificial intelligence model based on the text data or augmented data used for updating the metadata database.

16. The method as claimed in claim 15, wherein a prompt is stored in memory for obtaining the augmented data from the artificial intelligence model, and
wherein the augmented data is obtained based on inputting the text data and the prompt into the artificial intelligence model.

17. The controlling method as claimed in claim 16, wherein the augmented data comprises at least one of a genre, a title, a summary, a production year, or rating information, and
wherein the method further comprises updating the query history database with the augmented data.

18. The method as claimed in claim 11, further comprising:
transmitting the response data to an external device,
receiving a selection of at least a portion of the response data from the external device, and
matching the text data to the selection and store the matched text data and selection in the query history database.

19. The method as claimed in claim 12, further comprising, based on no records having a weight greater than or equal to the threshold value, transmitting the response data to an external device corresponding to a predetermined number of records in the metadata database having the highest weights.

20. A non-transitory computer-readable recording medium having at least one instruction recorded thereon, that, when executed by at least one processor, individually or collectively, cause the at least one processor to:
obtain text data based on a user input comprising a user inquiry;
based on a response data corresponding to the text data being not obtainable using a keyword corresponding to the obtained text data, and based on the response data corresponding to the text data not being included in a query history database, obtain the response data by using the text data with an artificial intelligence model; and
output a response to the user input based on the response data.
